(19) United States
(12) Patent Application Publication
(10) Pub. No.: US 2003/0227549 A1
(43) Pub. Date: Dec. 11, 2003

(54) Camera image recording putting during golf tournaments

(76) Inventors: Anthony L. Gambino, Carle Place, NY (US); John H. Williams, West Islip, NY (US)

Correspondence Address: MYRON AMER, P.C., Suite 310, 114 Old Country Road, Mineola, NY, 11501, US

(21) Appl. No.: 10/163,884

(22) Filed: Jun. 6, 2002

(51) Int. Cl. H04N 7/18

(52) U.S. Cl. 348/157; 348/143

(57) ABSTRACT

Occurring circumstances of play of golf not observed from the vantage point of attendees at a golf event, and captured in coverage of the golf event by a provided image displayed on a TV screen to significantly enhance the viewing enjoyment of a TV audience.

### CROSS REFERENCE TO RELATED APPLICATIONS

This application claims the benefit of United States Provisional Patent Application No. 60/295,741, filed on Jun. 4, 2001, the contents of which are incorporated herein by reference thereto.

The present invention relates generally to improvements in the TV broadcasting of golf events, and more particularly in using to advantage selected circumstances during the play of golf to provide a degree of realism significantly enhancing the enjoyment of an audience viewing the TV broadcast.

### EXAMPLES OF THE PRIOR ART

Currently TV broadcasting provides images duplicating for those not in attendance, i.e., a television audience, circumstances occurring during play witnessed by those in attendance, e.g. at a golf match, golf contest or golf-related event, but omits some circumstances of play not actually witnessed by attendees but which are of significant consequence and which, in accordance with the present invention are used to enhance the enjoyment of the television audience. This TV coverage with the noted prior art limitation of reporting only duplicating images is documented in prior patents, such as U.S. Pat. No. 5,102,140 for “Automated Hole-In-One Recording System” issued to Vincent on Apr. 7, 1992, U.S. Pat. No. 5,354,052 for “Hole-In-One Detector” issued to Nicholls et al. on Oct. 11, 1994, and U.S. Pat. No. 5,884,913 for “Golf Tee Shot-Green Placement Monitoring System” issued to Cohen on Mar. 23, 1999.

In the noted and in all other known patents, a monitoring camera records only what is readily observed, namely whether a hole-in-one has occurred in the '140 and '913 patents presumably in the absence of an observer on the putting green, and the closest to the putting green hole in a so-called, in golf parlance, a closest-to-the-pin contest in the '913 patent, but omits circumstances of play actually occurring but not readily observed, and which not being recorded is a missed opportunity to contribute to the fullest extent to maximizing audience interest in the golf event.

Broadly, it is an object of the present invention to overcome the foregoing and other shortcomings of the prior art.

More particularly, it is an object to provide an image of significant interest value to a TV audience that occurs during golf play but not observed by those in attendance in the manner herein provided, to thus favor TV coverage even over actual attendance, all as will be better understood as the description proceeds.

The description of the invention which follows, together with the accompanying drawings should not be construed as limiting the invention to the example shown and described, because those skilled in the art to which this invention appertains will be able to devise other forms thereof within the ambit of the appended claims.

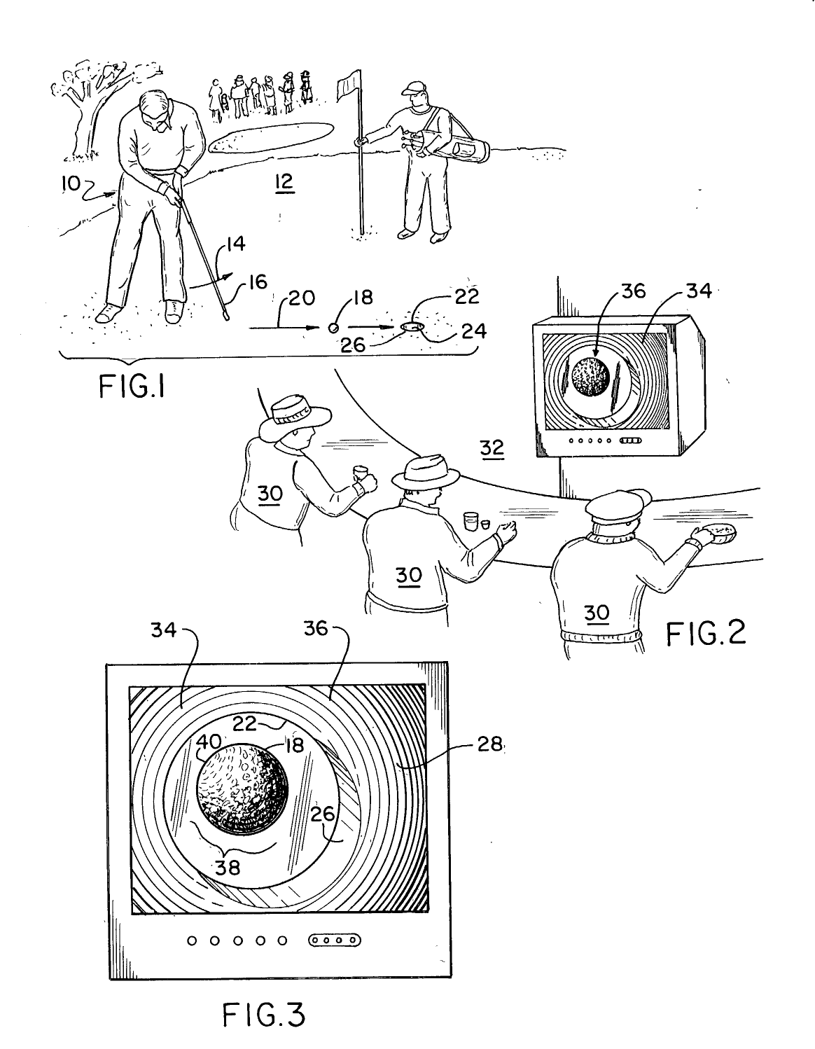

FIG. 1 is a perspective view of a golf tournament in progress;

FIG. 2 is a perspective view of an audience watching a TV broadcast of the golf tournament; and

FIG. 3 is a view, on an enlarged scale, of the TV-broadcast image seen by the audience.

During play of a golf tournament, as depicted in FIG. 1, a golfer 10 on a golf course putting green 12 will execute a putting stroke 14 with a putter 16 causing a golf ball 18 to roll along a path 20 with the object of entering within the confines of a circular edge 22 bounding an opening 24 opening into a cylindrical cup 26 bounded by a surrounding correspondingly cylindrical surface 28.

The circumstances of play, as depicted and just described, is viewed by an audience, as noted at 30, typically at a public facility 32 on a TV screen 34 on which an image, generally designated 36, is broadcast by transmission means, well understood, as to construction and operating mode, operatively connected between photographing means at the site of the putting green 12 and the TV screen 34, the viewing of the image 36 by the audience 30 being of significant interest value to the audience 30.

Underlying the present invention is the recognition that the play of golf requires for scoring the hole 24 on the putting green 12 serving as a target of the putting stroke 14, and that through such hole 24 there is ambient light transmission, as noted at 38, available as another condition of golf play by virtue of its nature as an outdoor sport, and wherein the extent of the noted ambient light transmission 38 is of an extent adequate for photographing. The photographing at the site 12 is by a camera that it will be understood to be at the bottom of the cup 22 and in facing relation therefrom upwardly to the hole opening 24. The photographed activity recorded by the camera is transmitted by known wireless technology to a broadcasting station which in turn is operatively connected to produce the image 36 on the TV screen 34.

Thus in accordance with the present invention, there is provided for viewing enjoyment of an audience 30 an image 36 presenting a display having at its center the hole bounding edge 22 in a circular shape, as display background the observed ambient condition provided by the light transmission through the circular shape, and as display foreground the observed peripheral edge 40 delimiting the size of the golf ball.

For completeness sake it is noted that the circular shape is of a diameter of 3¼ inches, the regulation size prescribed for the cup 22 of an approved professional golf association (PGA) golf tournament event, and that recommended for the photographing of the selected conditions of golf play according to the present invention is the model BED 20 camera commercially available from Hitachi Devshi, of Plainview, N.Y.

Optionally, a readily commercially available microphone can be positioned at the bottom of the cup 22 to record a movement of the ball 18 descending down the cup and, in practice, will also pick up conversation of golfers on the putting green 12 near the cup 22. This audio pickup accompanying the image display 36 significantly adds to the entertaiment value of the audience 30 watching the audio/visual broadcast being shown to the audience.

While the TV image herein shown and disclosed in detail is fully capable of attaining the objects and providing the advantages hereinbefore stated, it is to be understood that it is merely illustrative of the presently preferred embodiment of the invention and that no limitations are intended to the detail of construction or design herein shown other than as defined in the appended claims.

What is claimed is:

1. An image displayed on a screen of a TV for audience enjoyment and consisting of circumstances occurring in the play of a golf tournament, said displayed image comprising:
A. a TV having a display screen serving as a site for said displayed image in facing relation to an audience;
B. on said site a larger diameter circle of an edge bounding an opening into a hole of a golf course putting green forming a center of said displayed image;
C. ambient light viewed within said circle forming a background of said center of said displayed image as permitted by outdoor play of said golf tournament; and
D. a smaller diameter circle of a peripheral edge delimiting a size of a golf ball forming a foreground of said displayed image as a reported occurrence of a golfer putting a golf ball into said putting green hole;
whereby said displayed image contributes to the enjoyment of an audience watching a TV broadcast of said golf tournament.
